(19) United States
(12) Patent Application Publication
(10) Pub. No.: US 2013/0325534 A1
(43) Pub. Date: Dec. 5, 2013

(54) TERMINAL MANAGEMENT SYSTEM, MANAGEMENT SERVER, AND METHOD THEREFOR

(71) Applicant: Hitachi Solutions, Ltd., Tokyo (JP)

(72) Inventors: Daisuke FUKUI, Kawasaki-shi (JP); Shinya SASAKI, Yachiyo-shi (JP)

(73) Assignee: Hitachi Solutions, Ltd., Tokyo (JP)

(21) Appl. No.: 13/895,464

(22) Filed: May 16, 2013

(30) Foreign Application Priority Data
May 17, 2012 (JP) 2012-113199

(51) Int. Cl. G06Q 10/06

(52) U.S. Cl. CPC G06Q 10/0631
USPC 705/7.12

(57) ABSTRACT

Management server having a management table managing terminal management and control information management data models, in a common form The control information management data model manages control information for controlling the terminal. The management server executes plural processes. The first process is for creating the terminal management data model having the same data structure as that of the terminal management data model changed by the terminal. The second process is for creating the control information management data model, using control information regarding the terminal management data model based on an instruction from the management device. The third process is for registering the terminal management and control information management data models into the management table. The terminal executes a process based on the control information of the control information management data model acquired from the management server.

### CLAIM OF PRIORITY

The present application claims priority from Japanese application JP 2012-113199 filed on May 17, 2012, the content of which is hereby incorporated by reference into this application.

### BACKGROUND OF THE INVENTION

1. Field of the Invention

The present invention relates to a terminal management system, a management server, and the method therefor, and, more particularly, to a terminal management system, a terminal management server, and a terminal management method, for corresponding to functions and applications of a wide variety of business terminals such as a sensor, a mobile device, and the like.

2. Background of the Invention

In recent years, sensors and mobile devices have widely been used in the field of various industries. In a proposed system, the business terminals are connected to a server through a network line, and the server remotely manages and corresponds to the business terminals. For this server, what is required are the function extensibility corresponding to various kinds of target terminals to be managed and business applications as well as high performance data management under the assumption of controlling a large number of terminals.

In relation to the conventional terminal management system, Japanese Unexamined Patent Application Publication No. 2011-219197 discloses a sensor information management system which collects sensor information (regarding the temperature or humidity collected by the sensor in the field of distribution), location information (representing the packed condition of each article and the set location), and transportation route information, and stores all the information respectively in different tables. Then, the system searches for the sensor information of a specified article at a specified location, in accordance with a reference request from an external terminal, and provides the searched information.

Japanese Unexamined Patent Application Publication No. 2010-271934 discloses a device setting system, as a device setting server which sets a plurality of devices. The system stores and manages management data model information (representing device information corresponding to functions of devices) and policy information (representing services and devices in use in association with each other), respectively in different tables. The system specifies a combination of devices having functions necessary for providing services. The system transmits setting information necessary for executing services, to each specified device.

The conventional terminal management system disclosed in the above-described patent documents has problems in the function extensibility of the server and in the data management performance at the time of controlling the large number of terminals. That is, the conventional terminal management system executes a data process, based on the definition of the individual table configurations respectively for terminals or server functions. Thus, when different types of terminals or server functions are newly added and managed, many design changes are made in the data processing, making it difficult to extend the server functions at high speed and at low cost. It is difficult also to ensure the server processing performance when controlling a large number of terminals, in the terminal management system without consideration of load distribution in a data access process.

### SUMMARY OF THE INVENTION

An object of the present invention is to provide a terminal management system, a management server, and a terminal management method, for enabling to realize function extensibility corresponding to various target terminals to be managed or business applications as well as a high performance data management function under the assumption of managing a large number of terminals.

According to the present invention, there is provided a terminal management system comprising:
a management server which manages a state of and a change in a plurality of terminals connected with each other through a network; and
a management device which is connected to the management server through a network and instructs to change the state of each of the terminals,
wherein each of the terminals has a memory device which stores a terminal management data model expressing the state of each of the terminals with a data structure without depending on a type of the terminal,
the management server includes:
   a storage which stores a management table keeping and managing a terminal management data model having the same data structure as that of the terminal management data model of the terminal and a control information management data model for managing control information for controlling the terminal, in a common form,
a first processing section which creates a terminal management data model with the same data structure as that of the terminal management data model, when a change is made in the terminal management data model of the terminal;
   a second processing section which makes a change or addition in the terminal management data model of the terminal and creates the control information management data model using the control information regarding the terminal management data model, based on an instruction from the management device; and
   a third processing section which registers the terminal management data model and the control information management data model which are created by the first processing section and the second processing section, into the management table,
the management server reads the control information management data model from the management table, and transmits the read model to the terminal, in response to a request from the terminal, and
the terminal executes a process based on the control information of the control information management data model which is acquired from the management server.

Preferably, the management table manages the terminal management data model and the control information management data model, using a data structure having a common form; and
the data structure having the common form keeps a data model type representing an identifier identifying a kind of a data model, a data model ID identifying the data model, a data key representing an attribute name of data expressed in the data model, and a data value representing a value regarding the data key expressed in the data model.

Preferably, the management device has a display device displaying information on a screen, and an input device input and operated by an operator;
the display device enables to display a management screen which has a first display unit instructing to change the terminal management data model of the terminal and a second display unit instructing the terminal to add a new terminal management data model, and
when necessary information is input and instructed to be registered into the first display unit or the second display unit in accordance with an operation of the input device, the second processing section changes or adds contents of the terminal management data model or the control information management data model, based on the information input to the management screen.

Preferably, the first processing section creates the terminal management data model, using the data model type, the data model ID, the data key, and the data value; and
the second processing section creates the control information management data model, using the data model type, the data model ID, the data key, and the data value.

Preferably, each of the terminals keeps a terminal agent in a memory device of each terminal; and
the terminal agent creates the terminal management data model kept by a self terminal, or updates contents of the created terminal management data model, and executes a terminal control process based on the control information of the control information management data model acquired from the management server.

Preferably, the first processing section and the second processing section are realized by a processing device of the management server, executing a terminal control information registration program; and
the third processing section is realized by the processing device executing a data model operation program.

Preferably, the management table has division management tables which are divided into a plurality of divisions; and
the storage has a plurality of storages, and the plurality of storages store the divided division management tables.

Preferably, data is distributed and arranged in the divisions of the table data, based on a corresponding rule of the data model type and an arrangement destination of the storage.

Preferably, data is distributed and arranged in the divisions of the table data, based on a corresponding rule of a calculated result of a hash value of a character string including a data model type, an ID, and an attribute name in combination with each other and an arrangement destination of the storage.

According to the present invention, there is provided a management server, in a terminal management system, which is connected to a management device instructing to change a state of a corresponding terminal through a network, connected to a plurality of terminals through a network, and manages a state of and change in a state of the plurality of terminals, the server comprising:
a storage which stores a management table keeping and managing, in a common form, a terminal management data model of the terminal which has the same data structure as that of a terminal management data model expressing a state of the terminal with a data structure without depending on a type of the terminal and a control information management data model which manages control information for controlling the terminal;
a first processing section which creates a terminal management data model with the same data structure as that of the terminal management data model, when a change is made in the terminal management data model of the terminal;
a second processing section which makes a change or addition in the terminal management data model of the terminal and creates the control information management data model using the control information regarding the terminal management data model, based on an instruction from the management device; and
a third processing section which registers the terminal management data model and the control information management data model which are created by the first processing section and the second processing section, into the management table,
wherein the management server reads the control information management data model from the management table, and transmits the read model to the terminal, in response to a request from the terminal, to execute a process based on the control information of the control information management data model.

According to the present invention, there is provided a terminal management method in a terminal management system which has a management server, managing a state of and a change in a plurality of terminals connected with each other through a network, and a management device, connected to the management server through a network and instructing to change the state of each of the terminals, the method comprising:
a step of storing a terminal management data model expressing the state of each of the terminals with a data structure without depending on a type of the terminal, in a memory device, in each of the terminals;
a step of storing a management table keeping and managing a terminal management data model having the same data structure as that of the terminal management data model of the terminal and a control information management data model managing control information for controlling the terminal, in a common form, in the management server;
a first processing step of creating a terminal management data model with the same data structure as that of the terminal management data model, when a change is made in the terminal management data model of the terminal, in the management server;
a second processing step of making a change or addition in the terminal management data model of the terminal and creating the control information management data model using the control information regarding the terminal management data model, based on an instruction from the management device, in the management server;
a third processing step of registering the terminal management data model and the control information management data model which are created in the first processing step and the second processing step, into the management table, in the management server;
a step of reading the control information management data model from the management table and transmitting the read model to the terminal, in response to a request from the terminal, in the management server; and
a step of executing a process based on the control information of the control information management data model acquired from the management server, in the terminal.

According to the present invention, it is possible to realize function extensibility corresponding to various target terminals or business applications as well as a high performance data management function under the assumption of controlling the large number of terminals.

### BRIEF DESCRIPTION OF THE DRAWINGS

FIG. 1 is a diagram showing the overall configuration of a terminal management system in an embodiment (first embodiment);

FIG. 2 is a diagram showing a configuration example of a management server in the embodiment;

FIG. 3 is a diagram showing a configuration example of a terminal in the embodiment;

FIG. 4 is a diagram showing a configuration example of a data model management table in the embodiment;

FIG. 5 is a diagram showing an example of a management screen of a management device in the embodiment;

FIG. 6 is a flowchart showing the flow of a terminal management data model synchronization process in the embodiment;

FIG. 7 is a flowchart showing the flow of a binary registration process in the embodiment;

FIG. 8 is a flowchart showing the flow of a terminal control registration process in the embodiment;

FIG. 9 is a flowchart showing the flow of a terminal control execution process in the embodiment;

FIG. 10 is a diagram showing a configuration example of a management device in the embodiment;

FIG. 11 is a diagram showing the overall configuration of a terminal management system according to another embodiment (second embodiment);

FIG. 12 is a diagram showing a configuration example of a data model management table, when division management is performed by data model type, in the second embodiment; and

FIG. 13 is a diagram showing a configuration example of a data model management table, when division management is performed by a combination of data model type, data model ID, and data key, in the second embodiment.

### DESCRIPTION OF THE EMBODIMENTS

Embodiments of the present invention will now be described with reference to the accompanying drawings.

### First Embodiment

A first embodiment is to describe a terminal management system which uses a data model management table stored in a single storage. The first embodiment has a configuration preferable for operating the system on a simple server configuration, when the number of terminals is relatively small.

<Overall System Configuration>

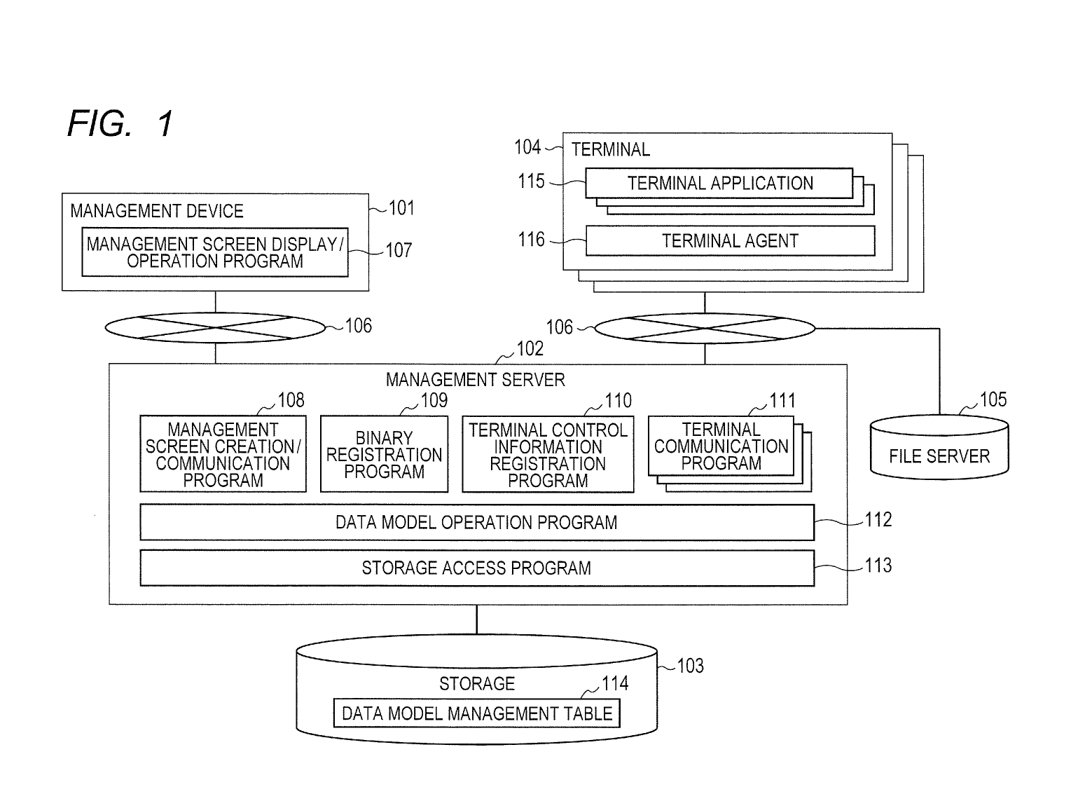

FIG. 1 illustrates a configuration of a terminal management system.

The terminal management system includes a management device 101, a management server 102, a storage 103, a number of target terminals 104 to be managed, and a file server 105, which are all connected through a network 106, such as the Internet, or the like. This terminal management system is applicable to a system which manages addition, updating, and deletion of management information for a wide variety of business terminals, through the management server 102. Note that the business terminals include cell phones, smart phones, and mobile terminals, and are used by staff members of, for example, enterprises. The terminal management system is applicable also to a system which manages management information for business terminals, such as a set-top box, a sensor, a communication device, and a machine tool, installed in a household, a building, a factory, and the like, through the management server 102.

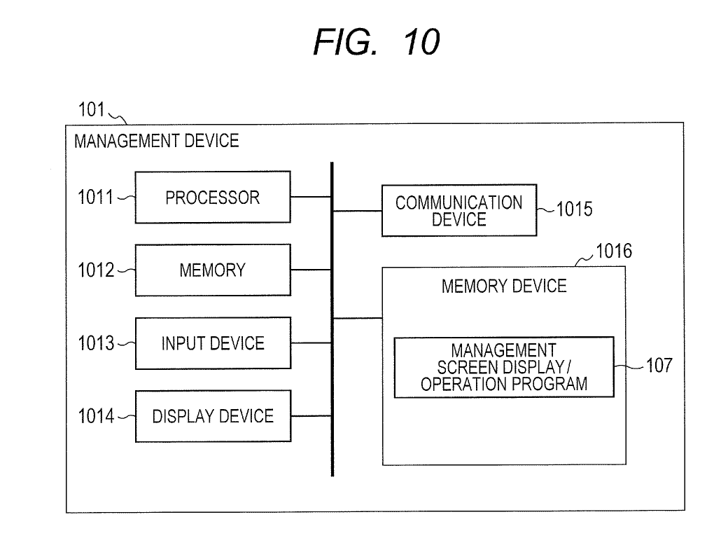

The management device 101 is an information processor such as a personal computer, which instructs to manage the terminals 104 in the terminal management system, and issues an instruction to change mainly the state of the terminals, in accordance with a manager operation. As illustrated in FIG. 10, the management device 101 includes, for example, a processor (CPU) 1011, a memory 1012, an input device 1013 (keyboard, mouse, etc.), a display device 1014 (display), a communication device 1015, and a memory device 1016. The processor 1011 performs various information processing upon execution of a program. The memory 1012 loads programs or data. The communication device 1015 establishes communication connections with other devices. These constituent units are connected with each other through an internal bus. The memory device 1016 stores a management screen display/operation program 107. The processor 1011 loads the management screen display/operation program 107 stored in the memory device into the memory 1012, and executes the program, to enable various input/output operations.

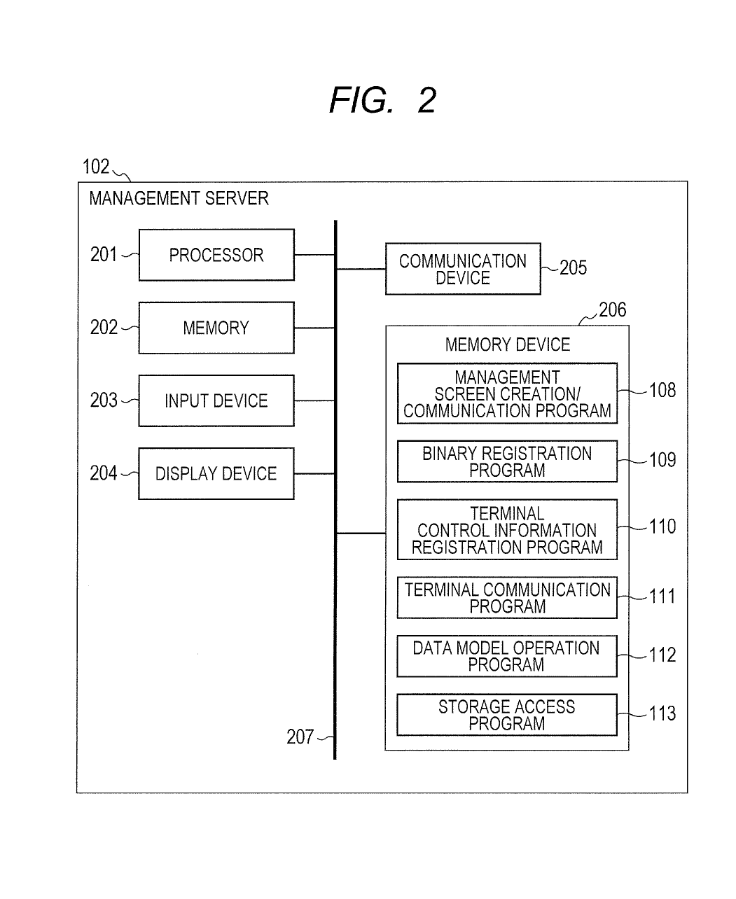

The management server 102 is an information processor which executes the fundamental processing in the terminal management system. The server 102 registers, updates, and manages state information and control information regarding the number of terminals. In this embodiment, a processor 201 (FIG. 2) can execute programs such as a management screen creation/communication program 108, a binary registration program 109, a terminal control information registration program 110, a terminal communication program 111, a data model operation program 112, and a storage access program 113. Note that the hardware configuration of the management server 102 will later be described with reference to FIG. 2.

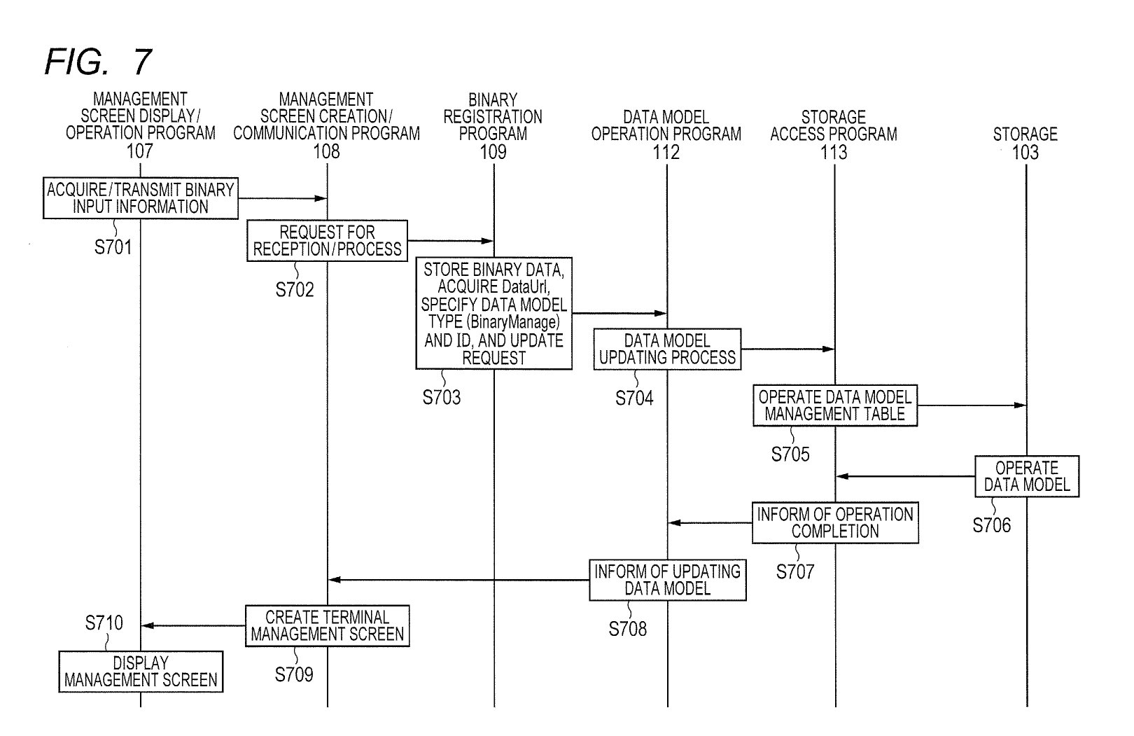

The management screen creation/communication program 108 realizes functions for creating a management screen displayed on a display device of the management device 101 and for providing the management device 101 with the created screen. The management screen creation/communication program 108 is executed in cooperation with the management screen display/operation program 107 included in the management device 107. The binary registration program 109 realizes functions for registering and updating for a binary management data model. This program is executed in a binary registration process (FIG. 7).

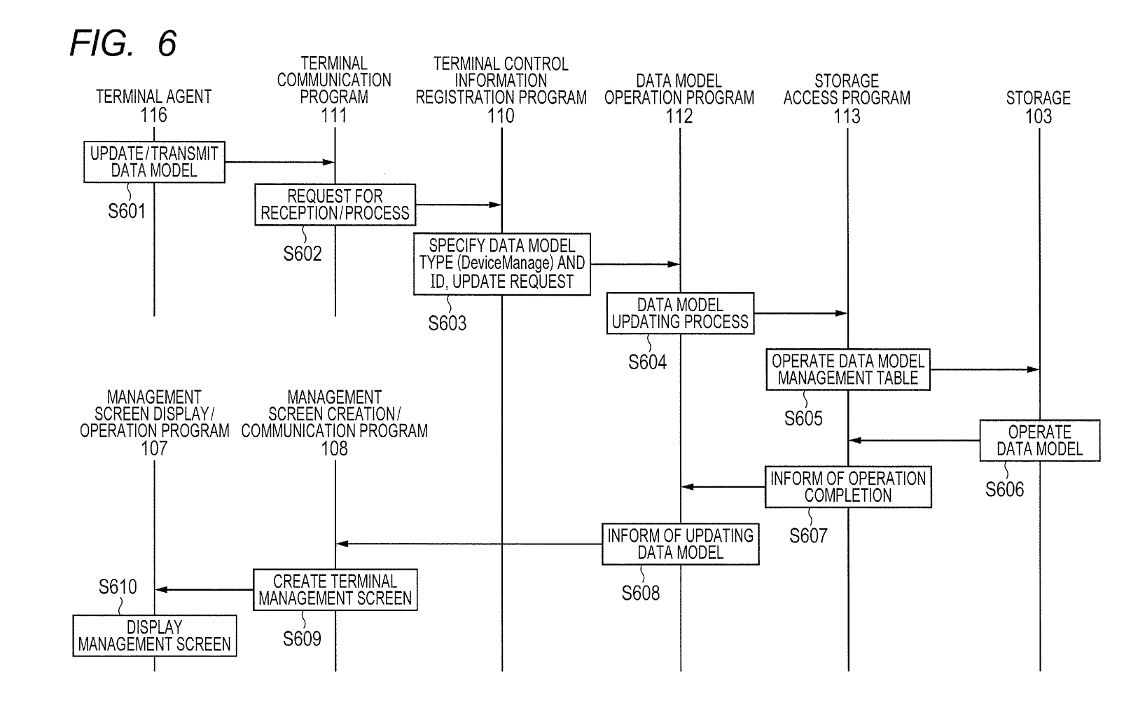

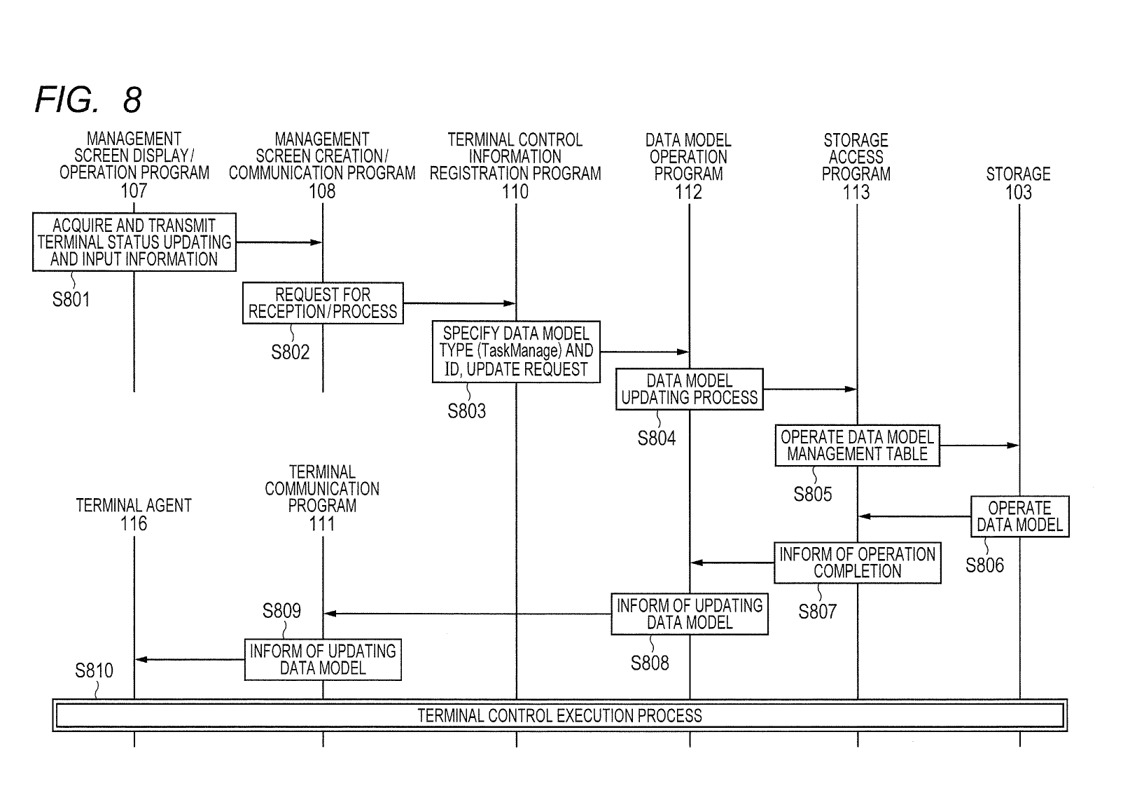

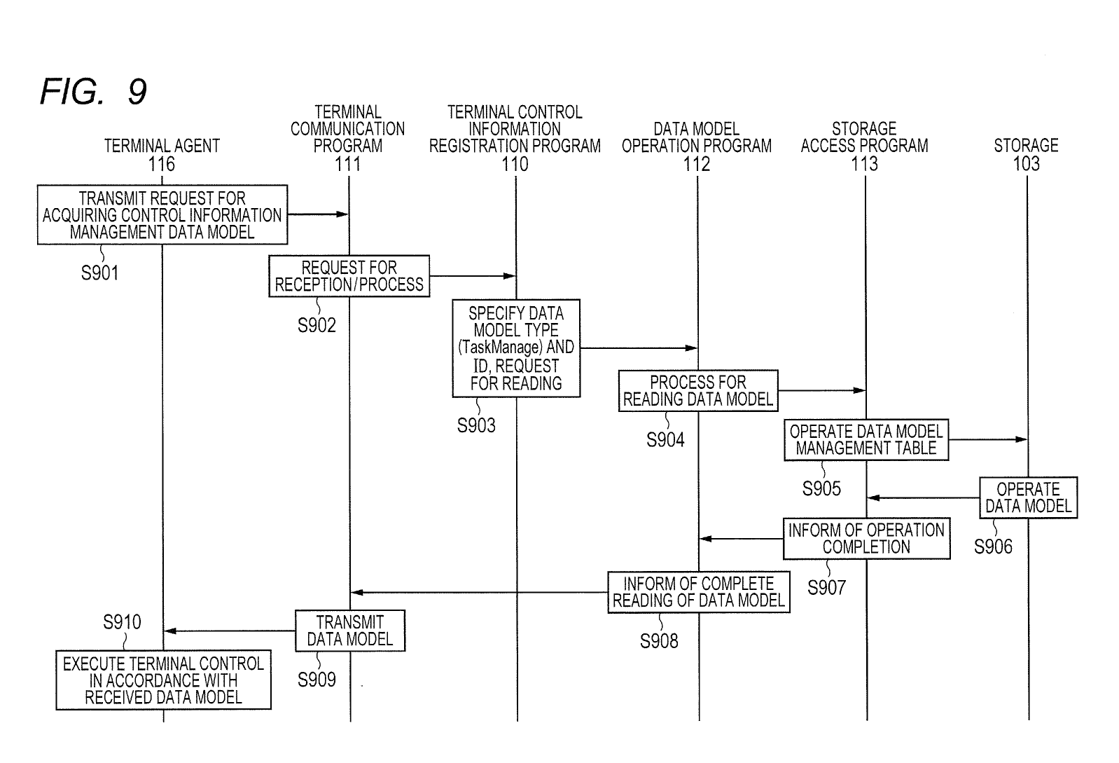

The terminal control information registration program 110 realizes a function for registering terminal control information for changing the state of the terminal 104, in a data model management table 114. This program is executed in a synchronization process for the terminal management data model (see FIG. 6), a terminal control information registration process (see FIG. 8), and a terminal control execution process (see FIG. 9). The terminal communication program 111 realizes a function for performing data communication with the terminals 104.

The data model operation program 112 realizes a function for changing the contents of the data model management table 114, based on an instruction of the terminal control information registration program 110 or the binary registration program 109. The storage access program 113 realizes a function for reading/writing the contents of the data model management table 103 stored in the storage.

Of these programs, the data model operation program 112 and the storage access program 113 function as a common unit of the present system, and other programs function as an extended unit thereof. Conventionally, the data models are defined for each of the terminals, and individually registered or updated in the management table. In this embodiment, however, the data models peculiar to the terminals or server functions are created or changed under the control of the terminal control information registration program 110, registration or updating processes for the data model management table 114 are commonalized by execution (execution by the common unit) of the data model operation program 112 and the storage access program 113. Thus, even if different types of terminals are newly added, and if a server function is newly added, those processes by the common unit can be executed without any changes. As a result, design changes can be minimized, and the server function can expectedly be extended at high speed and at low cost.

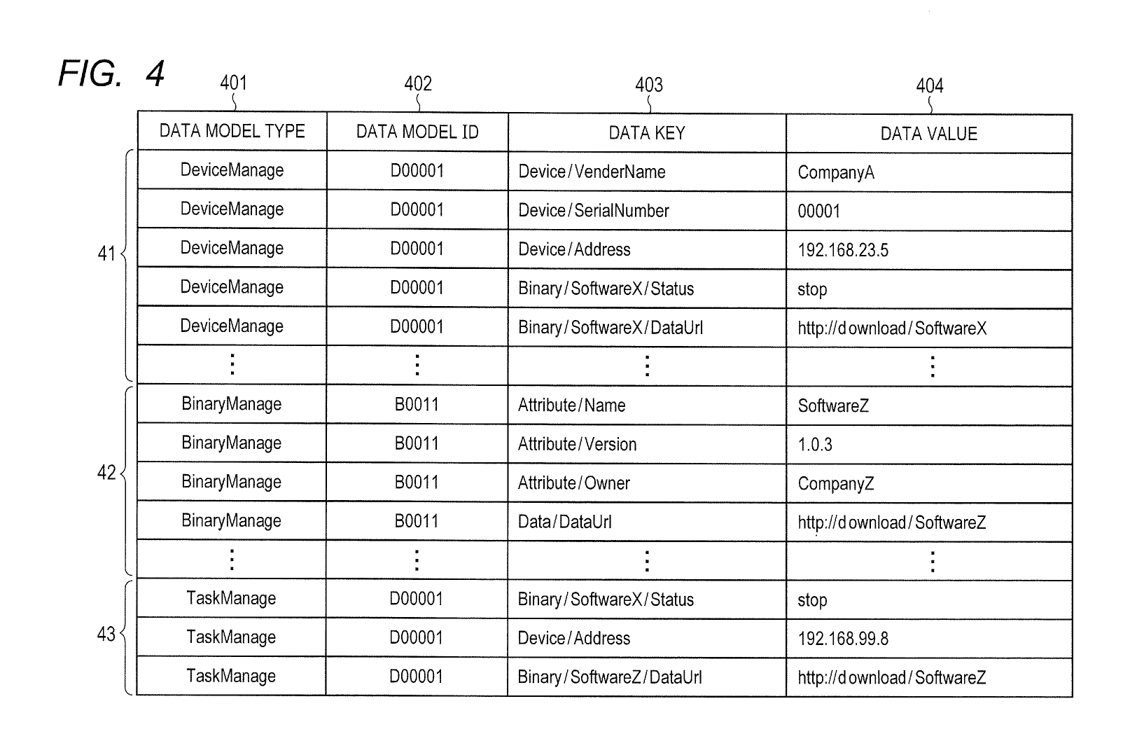

The storage 103 is a memory device which stores data other than a binary used by the management server 102, and is a memory device, such as an RDB (relational database). The storage 103 stores the data model management table 114 having the distinctive feature of this embodiment. The data model management table 114 will be described later with reference to FIG. 4.

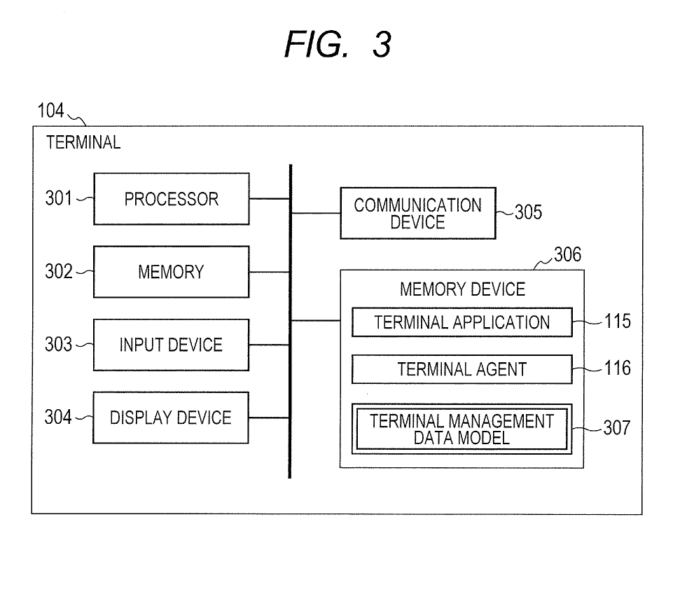

The terminal 104 is a business terminal, such as a mobile terminal or sensor, which is used in the terminal management system, and includes various functions and applications. Each of the terminals 104 can execute terminal application 115 and a terminal agent 116. The internal configuration example of the terminal 104 will be described later with reference to FIG. 3.

The terminal application 115 is a program for functioning services of the terminal 104, for example, a service for collecting sensor data. The terminal agent 116 is a program for executing terminal control such as changing the setting of the terminal 104 or updating the terminal application 115, in cooperation with the management server 102. Each terminal 104 creates a terminal management data model 307 (FIG. 3) with a data structure without depending on the terminal type, and stores the create model in the memory device, upon execution of the terminal agent 116. For example, some terminal status information (the manufacturer's serial number of the terminal 104 or the power source status of the software “X”) is used for creating the terminal management data model, such as “Device/SerialNumber=00001” or “Binary/SoftwareX/Status=running”.

Further, the terminal 104 performs terminal control in accordance with the updated contents of the data model, upon execution of the terminal agent 116. For example, if the data model of “Binary/SoftwareX/Status=running” is changed to “Binary/SoftwareX/Status=stop”, the active software “X” is controlled to stop.

The file server 105 is an information processor having a binary storage/distribution function with a Web server function. The server 105 stores a binary in response to a binary storage request from the management server 102, and provides address information for acquiring the stored binary through the network 106. In this embodiment, the binary is data or file in a data format other than the text format (character data), and is an execution file of, for example, the terminal application 115. <Internal Configuration of Management Server 102>

FIG. 2 shows an internal configuration example of the management server 102. The management server 102 includes a processor 201, a memory 202, an input device 203 (keyboard, mouse, etc.), a display device 204 (display), a communication device 205, and a memory device 206. The processor 201 performs execution or arithmetic operation of programs. The memory 202 loads the programs or data. The communication device 205 establishes communication connections with other devices. These constituent units are connected through an internal bus 207. The memory device 206 stores programs 108 to 113. The processor 201 loads the programs stored in the memory device 206 into the memory 202, and executes a process in accordance with instructions of the programs. <Internal Configuration of Terminal 104>

FIG. 3 shows an internal configuration example of the terminal 104. The terminal 104 includes a processor 301, a memory 302, an input device 303, a display device 304, a communication device 305, and a memory device 306. The processor 301 performs execution of programs. The memory 302 loads programs or data. The input device 303 is used by the user for an input operation. The display device 304 displays information. The communication device 305 establishes communication connections with other devices. These units are connected with each other through an internal bus. The terminals 104 may have various configurations, and some of them may not include an input device or a display device.

The memory device 306 stores the terminal application 115, the terminal management agent 116, and the terminal management data model 307 which is created by the process of the terminal management agent 116. The processor 301 loads the program stored in the memory device 306 into the memory 302, and executes a process in accordance with an instruction of the corresponding program. The terminal management data model 307 has the same data structure format as that of a terminal management data model 41 which is registered and managed in the data model management table 114.

<Data Model Management Table 114>

FIG. 4 shows a configuration of the data model management table 114. The data model management table 114 manages information necessary for operations of the terminal management system, except binary, in a common style with a structure of the data model. The data model management table 114 keeps and manages three data models of the terminal management data model 41, a binary management data model 42, and a control information management data model 43. The data model 41 manages the terminals 104 managed in this terminal management system. The data model 42 manages binaries which are used by this terminal management system. The data model 43 manages control information used for controlling the terminals 104. This control information includes an address or URL specifying the terminal, and instructions “start” and “stop” for activating and stopping the terminal.

A data model type 401 is an identifier specifying the kind of the data model. In this embodiment, the terminal management data model 41 is specified by an identifier “Device Manage”, the binary management data model 42 is specified by an identifier “Binary Manage”, and the control information management data model 43 is specified by an identifier “Task Manage”.

A data model ID 402 is an identifier for discriminating a target to be managed within the same data model type. The same data model ID is given to the target of the same data model type, as information for uniquely specifying a target to be managed and representing a set of a data key and a data value. However, how the data model ID is understood (how the information is used) differs between the data model types. In this embodiment, it is specified that the terminal management data models specified by different data model IDs “D00001” and “D00002” are terminal management data models of different terminals. In addition, it is specified that binary management data models specified by different data model IDs “B0011” and “B0012” are binary management data models of different binaries. It is also specified that control information management data models specified by different data model IDs “D00001” and “D00002” are control information data models for respective different terminals 104.

A data key 403 is an attribute name of data expressed in the form of a data model. For example, an attribute name “Device/Vendor Name” represents the manufacturer name of the terminal 104, an attribute name “BinarySoftwareX/Status” represents the active state of the software “X” operating on the terminal 104, and an attribute name “Binary/SoftwareX/DataUrl” represents a destination URL for downloading the binary of the software “X”. A data value 404 is a value corresponding to each data key of data expressed in the form of a data model.

<Management Screen>

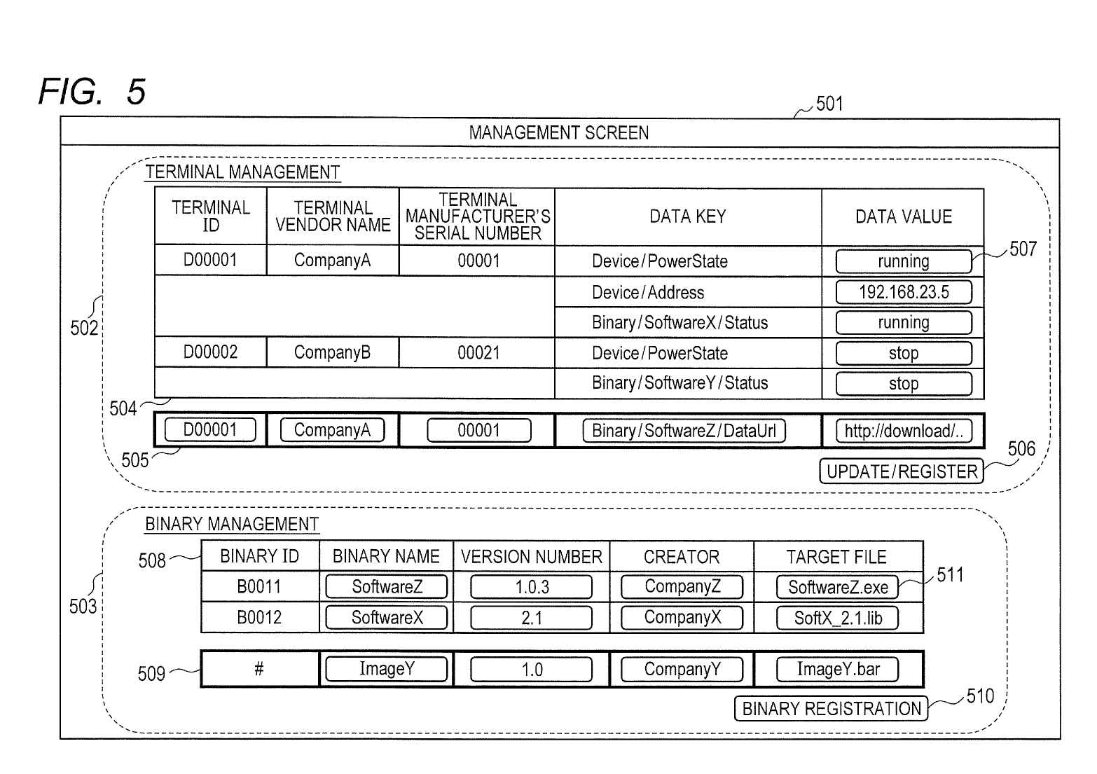

FIG. 5 shows an example of a management screen of the display device in the management device 101. The management screen is created upon execution of the management screen creation/communication program 108 in the management server 102, and displayed on the screen of the display device 1014 upon execution of the management screen display/operation program 107 in the management device 101.

A management screen 501 has a terminal management screen display unit 502 and a binary management screen display unit 503. The terminal management screen display unit 502 displays the state of the terminal 104, and provides a screen for editing the data model to control the terminal agent 116 of the terminal 104 to execute a control instruction. This terminal is specified by the terminal ID. The binary management screen display unit 503 displays binary information to be managed by the terminal management system, and provides a screen for registering a binary to be newly added as a target binary to be managed.

More specifically, the terminal management screen display unit 502 includes a terminal management data model display/editing unit 504, a terminal management data model adding unit 505, and an update/register button 506. The terminal management data model display/editing unit 504 displays the state of the terminal 104, based on the terminal management data model kept in the data model management table 114. The terminal management data model display/editing unit 504 includes items of data input boxes 507, as input display parts for inputting a terminal ID identifying the terminal, the terminal vendor name, terminal manufacturer's number, a data key, and a data value. The manager inputs data values in the data input boxes 507 through the input device 1013, and presses the update/register button 506, thereby informing the terminal agent 116 about updating of the terminal management data model.

The terminal management data model adding unit 505 includes input boxes for adding a new terminal management data model. The manager inputs data values corresponding to the above-described items into the terminal management data model adding unit 505 through the input device 1013, and presses the update/register button 506, thereby informing the terminal agent 116 about addition of a terminal management data model. FIG. 5 shows an example of instructing to add a data model in which a download URL of a binary is written. When binary information is specified for the terminal management data model, an input support screen may be concerned and prepared. This support screen is activated upon pressing of some of the data input boxes 507. For example, in the concerned screen, a list of binaries registered in the data model management table 114 is displayed on the management screen, and any of the binaries in the list is specified. Then, the download URL is input in a specified box. The update/register button 506 is a button for settling input values of the data input boxes 507 in the terminal management data model display/editing unit 504 or the terminal management data model adding unit 505.

The binary management screen display unit 503 has a binary management data model display/editing unit 508, a binary management data model adding unit 509, and a binary registration button 510. The binary management data model display/editing unit 508 displays binary information registered in the terminal management system, based on the binary management data model stored in the data model management table 114. The binary management data model display/editing unit 508 includes items “Binary ID” identifying a binary, “Binary Name”, “Version Number”, “Creator”, and “Target File Name”. The manager inputs a target file name through the input device 1013, and presses the binary registration button 510, thereby updating the binary registration information.

The binary management data model adding unit 509 includes input boxes for newly adding a binary to be managed by the terminal management system. The manager inputs attribute information of a binary to be newly managed and binary data, through the input device 1013, thereby registering the binary data. By performing binary registration, the download URL of the corresponding binary can be specified in the terminal management screen display unit 502. Data specification boxes 511 are boxes for specifying a target file of the binary management screen display unit 503. The binary registration button 510 is a button for settling input values of the data specification boxes 511 in the binary management data model display/editing unit 508 or the binary management data model adding unit 509.

<Process Flow of Terminal Management System>

Descriptions will now be made to the process flow of this terminal management system. In the terminal management system of this embodiment, both of a terminal management data model synchronization process of FIG. 6 and a binary registration process flow of FIG. 7 are executed, as a preparation process for changing the terminal setting or executing terminal control (updating the terminal application 115). After this preparation process, a terminal control registration process having the process flow in FIG. 8 is executed, thereby realizing the terminal control, in accordance with manager operations. FIG. 9 shows the process flow of the terminal control execution process which is activated upon completion of the terminal control registration process. Descriptions will specifically be made to these processes.

<Terminal Management Data Model Synchronization Process>

FIG. 6 shows the flow of the terminal management data model synchronization process. This synchronization process is a process for maintaining the uniformity of the data models of the terminal managed by both of the terminal and the management server. That is, when a changed is made in the data model of the terminals 104, this process is performed for conforming between the data model created based on the change and the data model of the terminal managed by the management server 102. This synchronization process is executed, immediately after the terminal agent 116 is introduced into the terminal 104, and also every time the terminal management agent 116 detects a change in the setting of the terminal 104.

The processor 301 of the terminal 104 receives an instruction of the terminal agent 116, and executes following processes. That is, at the activation of the terminal immediately after the terminal agent 116 is introduced into the terminal 104, the terminal agent 116 collects the state of the terminal application 115 operating on the terminal 104 and the state of the terminal 104 itself, creates the terminal management data model 307, and stores it in the memory device 306. This stored terminal management data model 307 is transmitted to the management server 102. Except immediately after the introduction of the terminal agent 116, the terminal agent 116 updates the terminal management data model 307 in accordance with the change in the setting of the terminal 104, and transmits the updated terminal management data model 307 to the management server 102 (S601).

In the management server 102, the processor 201 receives an instruction of the terminal communication program 111, receives the terminal management data model transmitted in S601, and requests the terminal control information registration program 110 for executing a process (S602).

The processor 201 receives an instruction of the terminal control information registration program 110, affixes a data model type and a data model ID to the terminal management data model acquired in S602, and requests the data model operation program 112 for updating the corresponding data model. In this process, an identifier “Device Manage” is specified. This identifier represents the terminal management data model as a data model type. The data model ID identifies each of the individual terminals based on a combination of a terminal vendor name and a terminal manufacturer's serial number, and specifies the serial number (for example, “D00001”) of each terminal (S603).

The processor 201 receives an instruction of the data model operation program 112, and performs a process for updating the data model required in S603. Specifically, the processor 201 requests the storage access program 113 to operate the data model management table 114, and waits for information about completion of the operation (S604).

The processor 201 receives an instruction of the storage access program 113, and executes a process for operating the data model management table 114, that is, rewriting the data for an updating process according to the operation request acquired in S604 (S605). The storage 103 operates the data model, that is, rewrites the data model management table 114, and sends completion information back to the storage access program 113 (S606).

The processor 201 receives an instruction of the storage access program 113, sends information about operation completion of the data model management table 114 to the data model operation program 112 (S607).

The processor 201 receives an instruction of the data model operation program 112, and informs the management screen creation/communication program 108 that the terminal management data model has been updated (S608).

The processor 201 receives an instruction of the management screen creation/communication program 108, receives information acquired in S608, reads information of the terminal management data model stored in the data model management table 114, creates a screen having the updated terminal management data model display/editing unit 504 of the management screen 501, and transmits the screen to the management device 101 (S609).

The processor 1011 in the management device 101 receives an instruction of the management screen display/operation program 107, and displays the management screen 501 received in S609 on the display device 1014 (S610). Accordingly, a series of procedures in the terminal management data model synchronization process is completed.

In the above-described process flow from S608 to S609, the processor 201 receives an instruction of the data model operation program 112, informs the management screen creation/communication program 108 of updating completion of the terminal management data model, and updates the terminal management data model display/editing unit 504. In these procedures, in S608, the processor 201 may end execution of the data model operation program 112 at the stage the terminal management data model has been updated, and when the management screen creation/communication program 108 is executed next time, the processor 201 may read the updated terminal management data model and update the terminal management data model display/editing unit 504.

<Binary Registration Process>

FIG. 7 shows the flow of a binary registration process. This process is for registering and updating the binary management data model in the data model management table 114 of the management server 102, based on an instruction from the management device 101. This process is executed, by the manager inputting binary data (including the execution file) into the data specification boxes 511 of the binary management data model display/editing unit 508 or the binary management data model adding unit 509 of the management screen, through the input device of the management device 101, and pressing the binary registration button 510.

The processor 1011 of the management device 101 receives an instruction of the management screen display/operation program 107, acquires input information input in the data specification boxes 511 of the binary management data model display/editing unit 508 and the binary management data model adding unit 509, and transmits the input information to the management server 102 (S701).

The processor 201 of the management server 102 receives an instruction of the management screen creation/communication program 108, receives the input information received in S701, and requests the binary registration program 109 for executing a process (S702).

The processor 201 receives an instruction of the binary registration program 109, affixes a data model type and a data model ID to the binary management data model acquired in S702, and requests the data model operation program 112 to update the data model. In this process, an identifier “Binary Manage” is specified. This identifier represents a binary management data model as a data model type. The data model ID identifies each of the individual binaries based on a combination of a binary name and a version number, and specifies the serial number (“B00001”) of each binary. Of the input information, target file information is replaced with a download URL in the next process. The processor 201 transmits the acquired target file information to the file server 105, requests for storage, and acquires a download URL as address information necessary for downloading the corresponding binary from the file server 105. After this, the processor 201 replaces the binary information with the download URL (S703).

The procedures from S704 to S707 (corresponding to a process by the common unit) are the same procedures as those from S604 to S607 (S704 to S707).

The processor 201 receives an instruction of the data model operation program 112, and informs the management screen creation/communication program 108 that the binary management data model has been updated (S708).

The processor 201 receives an instruction of the management screen creation/communication program 108, receives information acquired in S708, reads information of the binary management data model stored in the data model management table 114, updates the display of the binary management data model display/editing unit 508 of the management screen 501, and transmits the updated information to the management device 101 (S709).

The processor of the management device 101 receives an instruction of the management screen display/operation program 107, and displays the management screen 501 received in S709 on the display device (S710). Accordingly, a series of the binary registration process is completed.

In the process flow from S708 to S709, the processor 201 receives an instruction of the data model operation program 112, and informs the management screen creation/communication program 108 about updating completion of the binary management data model. Upon reception of this information, the binary management data model display/editing unit 508 is updated. In the procedures, it may be arranged that the processor 201 in S708 completes executing the data model operation program 112 at the stage where the binary management data model has been updated, reads the updated binary management data model when the management screen creation/communication program 108 is executed next time, and updates the binary management data model display/editing unit 508.

<Terminal Control Information Registration Process>

FIG. 8 shows the flow of a terminal control information registration process. This process is for registering/updating the control information management data model in the data model management table 114 of the management server 102, based on an instruction from the management device 101. This process is executed by the manager, inputting data values into the data input boxes 507 of the terminal management data model display/editing unit 504 or the terminal management data model adding unit 505 of the management screen 501, through the input device of the management device 101, and pressing the update/register button 506.

The processor in the management device 101 receives an instruction of the management screen display/operation program 107, acquires information input in the data input boxes 507 of the terminal management data model display/editing unit 504 and the terminal management data model adding unit 505, and transmits the information to the management server 102 (S801).

The processor 201 in the management server 102 receives an instruction of the management screen creation/communication program 108, receives the input information transmitted in S801, and requests the terminal control information registration program 110 for executing a process (S802).

The processor 201 receives an instruction of the terminal control information registration program 110, affixes a data model type and a data model ID to the input information of the terminal management data model acquired in S802, and requests the data model operation program 112 to store the corresponding data model. In this process, an identifier “Task Manage” is specified. This identifier represents a control information management data model as a data model type. The data model ID specifies a value of a terminal ID box of the terminal management screen display unit 502, as information identifying the target terminal agent 116 corresponding to a target data model to be updated (S803).

The procedures from S804 to S807 are the same procedures as those from S604 to S607 (S804 to S807).

The processor 201 receives an instruction of the data model operation program 112, and transmits, to the terminal communication program 111, information representing that the control information management data model has been updated (S808).

The processor 201 receives an instruction of the terminal communication program 111, and transmits the updating information about the updating of the control information management data model, to the terminal 104 (S809).

The processor 301 of the terminal 104 receives an instruction of the terminal management agent 116, and receives the updating information of the control information management data model. Then, the processor 301 starts a terminal control execution process (see FIG. 9) (S810). Accordingly, a series of terminal control registration process is completed.

<Terminal Control Execution Process>

FIG. 9 shows the flow of the terminal control execution process. In this process, the terminal 104 acquires control information management data model regarding the self terminal from the data model management table 114 of the management server 102, and controls the self terminal using the control information management data model. This process is executed, when the terminal 104 receives the updating information of the control information management data model in S809, or when the processor of the terminal 104 receives an instruction of the terminal agent 116, periodically checks the updating of the control information management data model on the management server 102, and detects the updating.

The processor 301 of the terminal 104 receives an instruction of the terminal agent 116, and transmits a request for acquiring the control information management data model to the management server 102, together with the terminal vendor name and the manufacturer's serial number of the terminal (S901). The processor 201 of the management server 10 receives an instruction of the terminal communication program 111, and transmits the terminal vendor name, the manufacturer's serial number, and the request for acquiring the control information management data model which are transmitted in S901, to the terminal control information registration program 110 (S902).

The processor 201 receives an instruction of the terminal control information registration program 110, specifies a data model ID (for example, “D00001”) of the terminal agent 116 based on the terminal vendor name and the manufacturer's serial number acquired in S902, and requests for reading a control information management data model, which has the same ID “D00001” registered in the data model ID 402 of the data model management table 114 and corresponds to a data model type “Task Manage” (S903).

The processor 201 receives an instruction of the data model operation program 112, and then executes a process for reading the data model acquired in S903. Specifically, the processor 201 transmits a request for operating the data model management table 114 to the storage access program 113, and waits for information about completion of the operation (S904). The procedures from S904 to S907 (procedures by the common unit) are the same as those procedures from S605 to S607 respectively (S905 to S907).

The processor 201 receives an instruction of the data model operation program 112, and then transmits the completely read control information management data model to the terminal communication program 111 (S908). The processor 201 receives an instruction of the terminal communication program 111, and transmits the control information management data model to the terminal 104 (S909).

The processor 301 of the terminal 104 receives an instruction of the terminal agent 116, and executes a control process based on information of the control information management data model which is received in S909. For example, when “Binary/SoftwareX/Status=stop” is received, the corresponding part of the terminal management data model 307 is updated, and the software X operating on the terminal 104 is stopped. When “Binary/SoftwareZ/DataUrl=http://download/SoftwareZ” is specified, the corresponding part of the terminal management data model 307 is updated, and the file server 105 is accessed using the specified download URL, and the binary is introduced into the terminal 104 (S910). After this terminal control execution process, the processed control information management data model is deleted from the data model management table 114.

### Second Embodiment

A second embodiment is an example in which the system is configured with the data model management table which is distributed and arranged in a plurality of storages. This embodiment is configured preferably for distributing the operational processing load of the data model management table and for operating the system with high performance, when many terminals 104 are controlled.

<System Configuration>

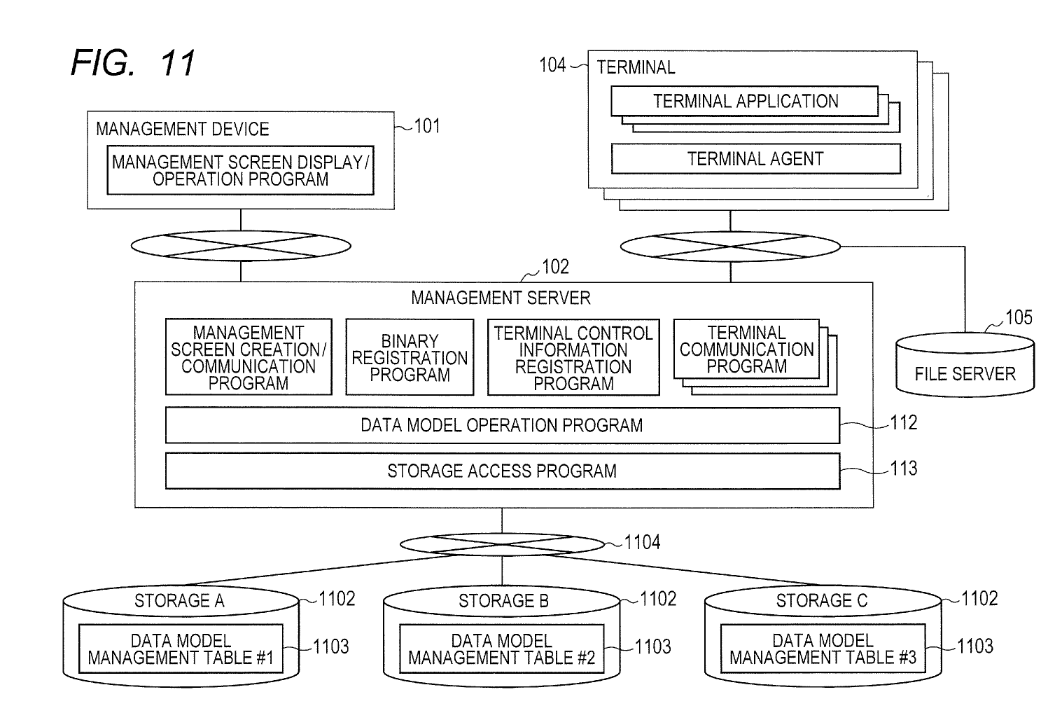

FIG. 11 shows the overall configuration of a terminal management system of this embodiment.

Unlike the first embodiment, there are a plurality of storages 1102, and a configuration of a data model management table 1103 differs between the both embodiments. That is, a plurality (three in the illustrated example) of storages 1102 are connected to the management server 102 through a network 1104 such as the Internet or SAN (Storage Area Network). Each of the plurality of storages 1102 stores a data model management table 1103. Other constituent elements are the same as those shown in FIG. 1.

<Internal Configuration>

The internal configuration of a management server 1101 is the same as that of FIG. 2 in the first embodiment. <Internal Configuration of Terminal>

The internal configuration of the terminal is the same as that of FIG. 3 in the first embodiment.

<Data Model Management Table>

The configuration of the data model management table 1103 is the same as that of FIG. 4 in the first embodiment.

<Management Screen>

The management screen is the same as the configuration of FIG. 5 in the first embodiment.

<Process Flow of Terminal Management System>

Some of the processing contents of the storage access program 113 differ from the process flow of the single storage configuration, illustrated in FIG. 6 to FIG. 9 in the first embodiment, and other processing contents are the same. Descriptions will now be made to differences from the process flow of the single storage configuration.

Instead of S605, S705, S805, and S905, the processor 201 of the management server 102 receives an instruction of the storage access program 113, and then executes the following process. The processor performs a determination process of a target storage 1102 for operation, in accordance with the contents of a data model operation request. A specific example of this process will specifically be described. After this, an operation process of the data model management table 1103 is executed for the determined target storage 1102 for executing an operation.

Instead of S607, S707, S807, and S907, the processor 201 of the management server 102 receives an instruction of the storage access program 113, and executes the next process. The processor 201 waits for operation completion information from the entire storages 1102 having requested for operation. When the operation completion information is received from the entire storages 1102, the processor sends back the operation completion information of the data model management table 1103 to the data model operation program 112.

<Specification of Determination Method of Target Storage for Operation>

The determination method executed in the above-described procedures S605, S705, S805, and S905 includes, for example, a determination method based on the data model type 401 of the operation requested data model, and a determination method based on a hash value obtained based on the operation requested data model.

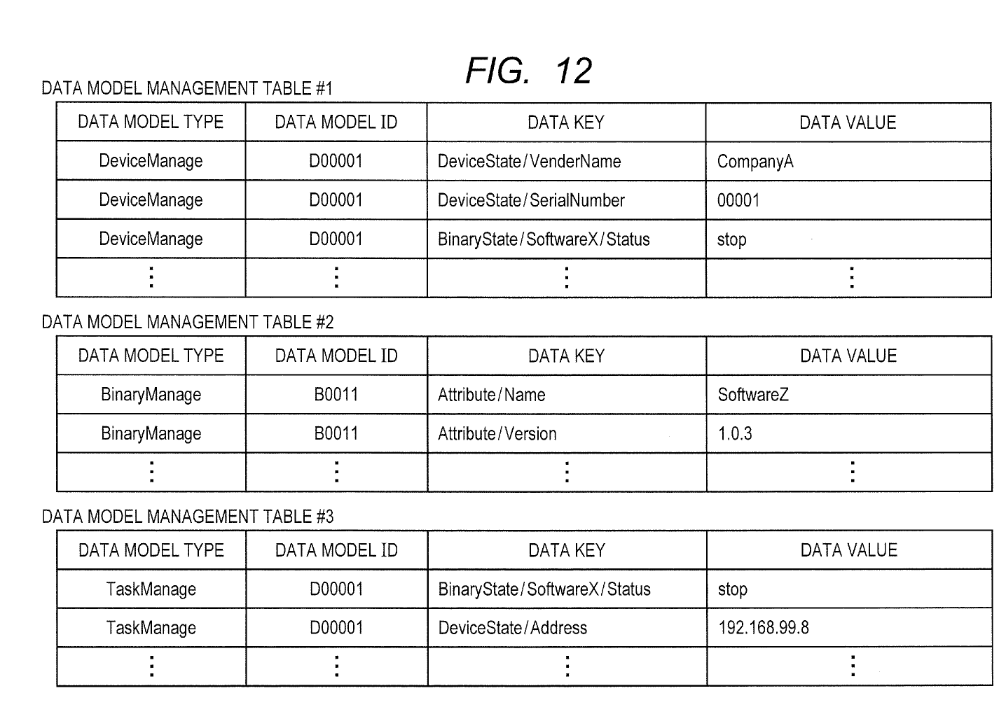

FIG. 12 shows a configuration example of the data model management table 1103, when the target storage 1102 for operation is determined based on the data model type 401. In this method, a setting file is stored in the memory device 206 in advance. This file represents the correspondence between the data model type 401 and the storage 1102. When the processor 201 executes a process after received an instruction of the storage access program 113, it determines a target storage with reference to the setting file. Based on this determination, when the data model type of the requested data model for operation is “Device Manage”, the storage A is operated. In addition, when the data model type is “Binary Manage”, the storage B is operated.

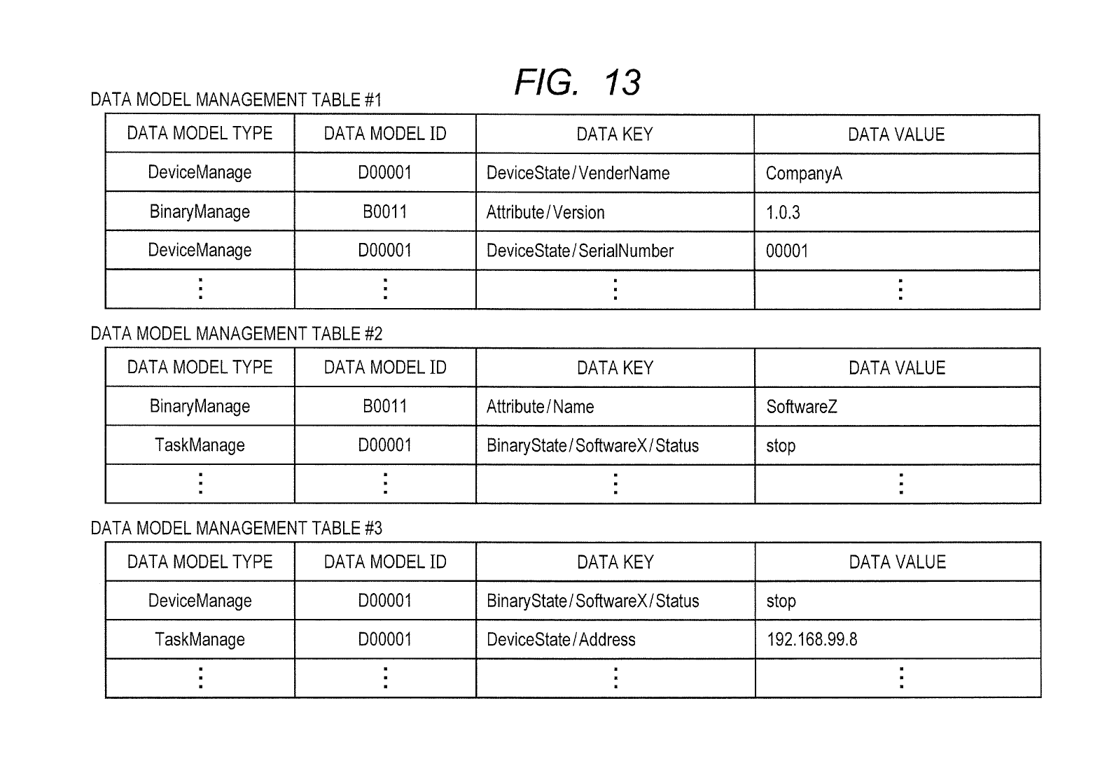

FIG. 13 shows a configuration example of the data model management table 1103, when the target storage 1102 for operation is determined based on a hash value of the data model. In this method, when a process is executed upon reception of an instruction of the storage access program 113, the processor 201 obtains a hash value of a character string including the data model type 401, the data model ID 402, and the data key 403, in combination with each other, which correspond to the operation-requested data model. The processor 201 also determines a target storage 1102 for operation, to store the corresponding hash value determined in advance. There are some methods for corresponding the hash value and the storage 1102. One method is provided for corresponding the remainder (of the hash value divided by the unit number of the storages 1102) and the storages 1102. Another method is provided for obtaining a hash value using peculiar information and for corresponding the hash value obtained based on the data model and a storage 1102 having the value closest to the obtained hash value based on the data model, using a Consistent Hashing method. The peculiar information includes network address information, in association with the individual storages 1102.

Modification

The embodiments 1 and 2 of the present invention have so far been described. Various changes may be made thereto without limiting the above-described embodiments. For example, in the embodiments 1 and 2, the management screen 501 has a function for displaying, editing, and adding the terminal management data model and the binary management data model. According to a modification, the management screen 501 may further have a function for deleting the data model. In this case, for example, in the management screen, a selection check box for each data model record is added, and a delete button is also added thereto. When the delete button is pressed, a deletion process for deleting the selected and checked record may be executed. In the management screen 501, a display/editing unit for a control information management data model may be added. This unit has the same function as that of the terminal management data model display/editing unit 504 and the binary management data model display/editing unit 508.

According to another modification, some terminal may not use the binary data. The file server 105 is not necessary for such a terminal. Thus, the binary management data model 42 of the data model management table 114, illustrated in FIG. 4, is not necessary.

According to the embodiments of the present invention, when a different type of terminal is newly managed or a server function is added, it is possible to use the common unit performing the data processing without any changes thereto. Therefore, the design changes can be minimized, and the server function can be extended at high speed and at low cost. Further, when a large number of terminals are managed, the data access is processed in a parallel distribution manner by the common unit, thus realizing high speed data access and ensuring the server processing performance.

The parallel distribution process of the data access, in this second embodiment, is entirely executed by the common unit, thus attaining the following effects. First, the storage configuration can be changed without changing the design of the extended unit, thus increasing/decreasing the number of storages which perform the distribution process in accordance with the increased/decreased number of management terminals after operating the terminal management system. This enables to adjust the cost of providing the storages in accordance with the size of the introduced system. Second, the extended unit can be developed without consideration of the parallel distribution process of the data access. Therefore, a high performance server function corresponding to the management for the large number of terminals can be developed at high speed and at low cost.

What is claimed is:

1. A terminal management system comprising:
a management server which manages a state of and a change in a plurality of terminals connected with each other through a network; and
a management device which is connected to the management server through a network and instructs to change the state of each of the terminals,
wherein each of the terminals has a memory device which stores a terminal management data model expressing the state of each of the terminals with a data structure without depending on a type of the terminal,
the management server includes:
a storage which stores a management table keeping and managing a terminal management data model having the same data structure as that of the terminal management data model of the terminal and a control information management data model for managing control information for controlling the terminal, in a common form;
a first processing section which creates a terminal management data model with the same data structure as that of the terminal management data model, when a change is made in the terminal management data model of the terminal;
a second processing section which makes a change or addition in the terminal management data model of the terminal and creates the control information management data model using the control information regarding the terminal management data model, based on an instruction from the management device; and
a third processing section which registers the terminal management data model and the control information management data model which are created by the first processing section and the second processing section, into the management table,
the management server reads the control information management data model from the management table, and transmits the read model to the terminal, in response to a request from the terminal, and
the terminal executes a process based on the control information of the control information management data model which is acquired from the management server.

2. The terminal management system according to claim 1,
wherein the management table manages the terminal management data model and the control information management data model, using a data structure having a common form; and
the data structure having the common form keeps a data model type representing an identifier identifying a kind of a data model, a data model ID identifying the data model, a data key representing an attribute name of data expressed in the data model, and a data value representing a value regarding the data key expressed in the data model.

3. The terminal management system according to claim 1,
wherein the management device has a display device displaying information on a screen, and an input device input and operated by an operator;
the display device enables to display a management screen which has a first display unit instructing to change the terminal management data model of the terminal and a second display unit instructing the terminal to add a new terminal management data model, and
when necessary information is input and instructed to be registered into the first display unit or the second display unit in accordance with an operation of the input device, the second processing section changes or adds contents of the terminal management data model or the control information management data model, based on the information input to the management screen.

4. The terminal management system according to claim 2,
wherein the first processing section creates the terminal management data model, using the data model type, the data model ID, the data key, and the data value; and
the second processing section creates the control information management data model, using the data model type, the data model ID, the data key, and the data value.

5. The terminal management system according to claim 1,
wherein each of the terminals keeps a terminal agent in a memory device of each terminal; and
the terminal agent creates the terminal management data model kept by a self terminal, or updates contents of the created terminal management data model, and executes a terminal control process based on the control information of the control information management data model acquired from the management server.

6. The terminal management system according to claim 1,
wherein the first processing section and the second processing section are realized by a processing device of the management server, executing a terminal control information registration program; and
the third processing section is realized by the processing device executing a data model operation program.

7. The terminal management system according to claim 1,
wherein the management table has division management tables which are divided into a plurality of divisions; and
the storage has a plurality of storages, and the plurality of storages store the divided division management tables.

8. The terminal management system according to claim 7, wherein data is distributed and arranged in the divisions of the table data, based on a corresponding rule of the data model type and an arrangement destination of the storage.

9. The terminal management system according to claim 7, wherein data is distributed and arranged in the divisions of the table data, based on a corresponding rule of a calculated result of a hash value of a character string including a data model type, an ID, and an attribute name in combination with each other and an arrangement destination of the storage.

10. A management server which is connected to a management device instructing to change a state of a corresponding terminal through a network, connected to a plurality of terminals through a network, and manages a state of and change in a state of the plurality of terminals, the server comprising:
a storage which stores a management table keeping and managing, in a common form, a terminal management data model of the terminal which has the same data structure as that of a terminal management data model expressing a state of the terminal with a data structure without depending on a type of the terminal and a control information management data model which manages control information for controlling the terminal;
a first processing section which creates a terminal management data model with the same data structure as that of the terminal management data model, when a change is made in the terminal management data model of the terminal;
a second processing section which makes a change or addition in the terminal management data model of the terminal and creates the control information management data model using the control information regarding the terminal management data model, based on an instruction from the management device; and
a third processing section which registers the terminal management data model and the control information management data model which are created by the first processing section and the second processing section, into the management table,
wherein the management server reads the control information management data model from the management table, and transmits the read model to the terminal, in response to a request from the terminal, to execute a process based on the control information of the control information management data model.

11. A terminal management method in a terminal management system which has a management server, managing a state of and a change in a plurality of terminals connected with each other through a network, and a management device, connected to the management server through a network and instructing to change the state of each of the terminals, the method comprising:
a step of storing a terminal management data model expressing the state of each of the terminals with a data structure without depending on a type of the terminal, in a memory device, in each of the terminals;
a step of storing a management table keeping and managing a terminal management data model having the same data structure as that of the terminal management data model of the terminal and a control information management data model managing control information for controlling the terminal, in a common form, in the management server;
a first processing step of creating a terminal management data model with the same data structure as that of the terminal management data model, when a change is made in the terminal management data model of the terminal, in the management server;
a second processing step of making a change or addition in the terminal management data model of the terminal and creating the control information management data model using the control information regarding the terminal management data model, based on an instruction from the management device, in the management server;
a third processing step of registering the terminal management data model and the control information management data model which are created in the first processing step and the second processing step, into the management table, in the management server;
a step of reading the control information management data model from the management table and transmitting the read model to the terminal, in response to a request from the terminal, in the management server; and
a step of executing a process based on the control information of the control information management data model acquired from the management server, in the terminal.

12. The terminal management method according to claim 11,
wherein the management table manages the terminal management data model and the control information management data model, using a data structure having a common form; and
the data structure having the common form keeps a data model type representing an identifier identifying a kind of a data model, a data model ID identifying the data model, a data key representing an attribute name of data expressed in the data model, and a data value representing a value regarding the data key expressed in the data model.

13. The terminal management method according to claim 11,
wherein the management device has a display device displaying information on a screen, and an input device input and operated by an operator;
the display device enables to display a management screen which has a first display unit instructing to change the terminal management data model of the terminal and a second display unit instructing the terminal to add a new terminal management data model, and
when necessary information is input and instructed to be registered into the first display unit or the second display unit in accordance with an operation of the input device, the second processing section changes or adds contents of the terminal management data model or the control information management data model, based on the information input to the management screen.

14. The terminal management method according to claim 12,
wherein the first processing section creates the terminal management data model, using the data model type, the data model ID, the data key, and the data value; and
the second processing section creates the control information management data model, using the data model type, the data model ID, the data key, and the data value.

15. The terminal management method according to claim 11,
wherein each of the terminals keeps a terminal agent in a memory device of each terminal; and
the terminal agent creates the terminal management data model kept by a self terminal, or updates contents of the created terminal management data model, and executes a terminal control process based on the control information of the control information management data model acquired from the management server.

16. The terminal management method according to claim 11,
wherein the first processing section and the second processing section are realized by a processing device of the management server, executing a terminal control information registration program; and
the third processing section is realized by the processing device executing a data model operation program.

17. The terminal management method according to claim 11,
wherein the management table has division management tables which are divided into a plurality of divisions; and
the storage has a plurality of storages, and the plurality of storages store the divided division management tables.

18. The terminal management method according to claim 17, wherein data is distributed and arranged in the divisions of the table data, based on a corresponding rule of the data model type and an arrangement destination of the storage.
